(19) United States
(12) Patent Application Publication
(10) Pub. No.: US 2025/0132447 A1
(43) Pub. Date: Apr. 24, 2025

(54) BATTERY PACK FOR VEHICLE

(71) Applicants: Hyundai Motor Company, Seoul (KR); Kia Corporation, Seoul (KR)

(72) Inventors: Kyung Mo KIM, Hwaseong-si (KR); Gun Woo KO, Seongnam-si (KR)

(21) Appl. No.: 18/816,890

(22) Filed: Aug. 27, 2024

(30) Foreign Application Priority Data
Oct. 23, 2023 (KR) 10-2023-0142104

(51) Int. Cl. H01M 50/293; H01M 50/249; H01M 50/262

(52) U.S. Cl. CPC H01M 50/293; H01M 50/249; H01M 50/262; H01M 2220/20

(57) ABSTRACT

A battery pack for a vehicle includes a lower casing in which a plurality of battery modules is seated, and a crossing member disposed to cross the lower casing along a widthwise direction between the battery modules seated to be adjacent in a lengthwise direction, being in close contact with end plates of the battery modules, lateral sides of which face each other, and being fastened to the lower casing together with a pair of end plates disposed at both lateral sides.

### CROSS REFERENCE TO RELATED APPLICATION

The present application claims priority to Korean Patent Application No. 10-2023-0142104, filed on Oct. 23, 2023, the entire contents of which are incorporated herein for all purposes by this reference.

### TECHNICAL FIELD

The disclosure relates to a structure of a battery pack loaded on a vehicle.

### BACKGROUND

An electric vehicle or the like includes an electric motor to generate a driving force for the vehicle, and a battery pack is loaded on the electric vehicle or the like to supply electric power to the electric motor.

The battery pack may include a plurality of battery modules mounted thereto, and the battery module may include a plurality of battery cells stacked together.

A main factor that affects the range of the vehicle loaded with the battery pack is the volume percentage of the battery cells loaded on the vehicle. In other words, the range of the vehicle increases as a space forming the battery pack is loaded with as many battery cells or battery modules as possible.

Currently, as the battery cell, the battery module, and the battery pack are individually modularized and provided with covers and housings, the volume percentage of ancillary components such as mechanical components for mechanical rigidity, heat dissipation/cooling components for cooling the battery, and components for heat insulation/electric insulation from the outside is larger than the volume percentage of the battery cells, and thus it is disadvantageous to ensure the range of the vehicle.

Accordingly, it is important to minimize an overlap of mechanical rigidity functions among the battery cell, the battery module, and the battery pack, and maximize the volume percentage of the battery cells while maintaining the same cooling and insulating performance and durability as before by using multifunctional integrated component having a cooling function, a cell housing function, a mechanical rigid function, etc.

The matters described as the related art are merely intended to promote the understanding of the background of the disclosure, but should not be accepted as recognition of the prior art that has already been known to a person having ordinary knowledge in the art.

### SUMMARY

The disclosure is proposed to solve the foregoing problems, and an aspect of the disclosure is to provide a battery pack for a vehicle, in which the number of battery cells loaded into the battery pack is maximized, and the structural rigidity of the battery pack is sufficiently ensured.

Technical problems to be solved in the disclosure are not limited to the forementioned technical problems, and other unmentioned technical problems can be clearly understood from the following description by a person having ordinary knowledge in the art to which the disclosure pertains.

According to one aspect of the subject matter describe di this application, a battery pack for a vehicle includes: a plurality of battery modules; a lower casing that supports the plurality of battery modules; a crossing member that extends across the lower casing along a widthwise direction of the lower casing, the crossing member being disposed between adjacent battery modules among the plurality of battery modules that are disposed adjacent to each other in a lengthwise direction crossing the widthwise direction; and a pair of end plates that are disposed at lateral sides of the adjacent battery modules and face each other, wherein the cross member is in contact with the pair of end plates and fastened to the lower casing together with the pair of end plates.

For example, a lower end portion of at least one end plate of the pair of end plates may be curved and overlap with a lower end portion of the crossing member, and the lower end portion of the crossing member may be fastened to the lower casing along with the lower end portion of the at least one end plate.

For example, lower end portions of the pair of end plates may be curved, so that the lower end portions overlap with each other, and the lower end portion of the crossing member may be fastened to the lower casing along with the lower ends of the end plates.

For example, the battery pack may further include a plurality of first fastening bolts that couple the crossing member to the lower casing together with the pair of end plates, the crossing member may include a plurality of fastening portions that extends through the crossing member in a vertical direction, each of the plurality of fastening portions receiving one of the plurality of first fastening bolts.

For example, the crossing member may be made of metal and molded by a casting process.

For example, the crossing member may include a plurality of recessed portions that are recessed in the lengthwise direction from lateral surface of the crossing member facing the lateral sides of the adjacent battery modules, and each of the plurality of recessed portions is disposed between two of the plurality of fastening portions.

For example, the lower casing may include a plurality of cooling channels, and a plurality of fastening taps that are disposed so as not to overlap the plurality of cooling channels, and spaced apart from one another in the widthwise direction of the crossing member, the plurality of first fastening bolts are fastened to the plurality of fastening taps, respectively.

For example, each of the pair of the end plates may include a plurality of guide portions that protrude from a lateral side thereof and are in contact with a lateral surface of the crossing member.

For example, the pair of end plates may be made of metal, and the plurality of guide portions is made of plastic and disposed at the lateral side of the pair of end plates by an insert-injection molding process.

For example, the crossing member may include a plurality of recessed portions formed on at the lateral surface of the crossing member, a plurality of lower ribs disposed below the plurality of recessed portions, and a plurality of guide grooves formed at the plurality of lower ribs at positions corresponding to the plurality of guide portions, the plurality of guide portions may be configured to pass through the plurality of guide grooves, respectively, based on the crossing member moving relative to the pair of end plates from a position above the pair of end plates, and the crossing member may be configured to be inserted between the pair of end plates based on moving relative to the pair of end plates from the position above the pair of end plates to a position in which the plurality of guide portions are positioned above the plurality of recessed portions of the crossing member.

For example, the lower casing may include a plurality of side members that form side surfaces of the lower casing, the plurality of battery modules and the crossing member may be disposed between the plurality of side members of the lower casing, each of the side members may include a connection bracket disposed at an inner side thereof, and the crossing member may include end portions that are fastened to the connection brackets of the side members, respectively.

For example, the crossing member may include protrusions that protrude laterally outwards from upper portions of the end portions of the crossing member, respectively, and the crossing member may be inserted to the lower casing from a position above the lower casing based on the protrusions being fastened to top portions of the connection brackets, respectively.

For example, the connection brackets may be spaced apart from each other and face each other in the widthwise direction of the lower casing, and the crossing member may be disposed between the connection brackets.

For example, the battery pack may further include at least one second fastening bolt that is inserted from above one of the protrusions and fastens the one of the protrusions to one of the connection brackets.

For example, the crossing member may have lateral end surfaces that are inclined inward with respect to the side members, respectively, such that a width of the crossing member decreases toward the lower casing, and a space between one of the lateral end surfaces of the crossing member and one of the connection brackets may increase toward the lower casing.

For example, both lateral surfaces of each of the connection brackets may be in contact with the pair of end plates, and the end portions of the crossing member may be fastened to the connection brackets together with the pair of end plates that are in contact with the lateral surfaces of each of the connection brackets.

For example, upper end portions of the pair of end plates may be curved in contact with an upper end portion of each of the connection brackets, and the end portions of the crossing member may be fastened to the connection brackets, respectively, along with the upper end portions of the pair of end plates.

For example, the upper end portions of the pair of end plates may be stacked, and each of the end portions of the crossing member may be fastened to one of the connection brackets along with the upper end portions of the pair of end plates.

As described above, the number of battery cells to be loaded into the battery pack is maximized in the battery pack for the vehicle according to the disclosure, thereby maximizing the range of the vehicle.

In addition, the structural rigidity is sufficiently ensured through the crossing member inserted between the battery modules even though ancillary components are reduced, thereby improving structural stability.

Further, the crossing member is fastened to the battery modules inside the casing of the battery pack, thereby ensuring the airtight performance of the casing even in the event of vibration and shock.

Effects obtainable from the disclosure may not be limited by the aforementioned effects, and other unmentioned effects can be clearly understood from the following description by a person having ordinary knowledge in the art to which the disclosure pertains.

### BRIEF DESCRIPTION OF THE DRAWINGS

FIG. 1 is an exploded perspective view of an example of a battery pack for a vehicle.

FIG. 2 is a perspective view showing an example of a lower casing.

FIG. 3 is a perspective view showing an example of a crossing member.

FIG. 4 is an enlarged view of “A” in FIG. 1.

FIG. 5 is an enlarged view of “B” in FIG. 1.

FIG. 6 is a perspective view showing a battery back for a vehicle with a top cover removed.

FIG. 7 is a view showing a cross-section taken along line I-I of FIG. 6.

FIG. 8 is a view showing a cross-section taken along line II-II of FIG. 6.

FIG. 9 is an enlarged view of “C” in FIG. 6.

FIG. 10 is an enlarged view of “D” in FIG. 6.

FIG. 11 is an enlarged view of “E” in FIG. 6.

### DETAILED DESCRIPTION

In terms of describing the embodiments of the disclosure, detailed descriptions of related art will be omitted when they may make the subject matter of the embodiments of the disclosure rather unclear. In addition, the accompanying drawings are provided only for a better understanding of the embodiments of the disclosure and are not intended to limit technical ideas of the disclosure. Therefore, it should be understood that the accompanying drawings include all modifications, equivalents and substitutions within the scope and sprit of the disclosure.

Terms such as “first” and “second” may be used to describe various components, but the components should not be limited by the above terms. In addition, the above terms are used only for the purpose of distinguishing one component from another.

When it is described that one component is “connected” or “joined” to another component, it should be understood that the one component may be directly connected or joined to another component, but additional components may be present therebetween. However, when one component is described as being “directly connected,” or “directly coupled” to another component, it should be understood that additional components may be absent between the one component and another component.

Unless the context clearly dictates otherwise, singular forms include plural forms as well.

In the disclosure, it should be understood that term “include” or “have” indicates that a feature, a number, a step, an operation, an element, a part, or the combination thereof described in the embodiments is present, but does not preclude a possibility of presence or addition of one or more other features, numbers, steps, operations, elements, parts or combinations thereof, in advance.

Hereinafter, one or more implementations of the disclosure will be described in detail with reference to the accompanying drawings, in which the same or similar elements are denoted by the same reference numerals even though they are depicted in different drawings and redundant descriptions thereof will be avoided.

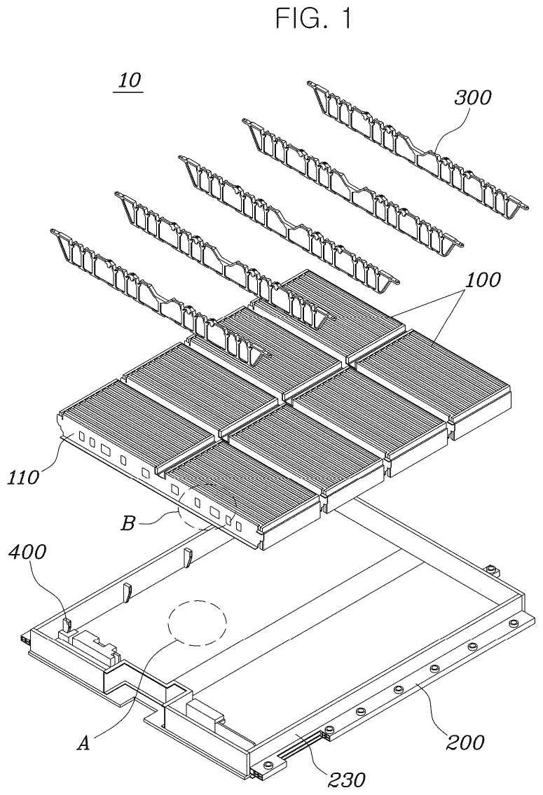

Various elements of a battery pack for a vehicle will be described with reference to FIG. 1.

FIG. 1 is an exploded perspective view of a battery pack for a vehicle according to an implementation of the disclosure.

In some implementations, referring to FIG. 1, the battery pack 10 for the vehicle may include a battery module 100, a lower casing 200, and a crossing member 300. FIG. 1 shows elements mainly related to the implementation of the disclosure. Of course, the battery pack 10 may actually include fewer or more elements.

In a conventional battery pack, a battery module refers to a plurality of battery cells stacked and enclosed with a separate housing. A plurality of such battery modules is mounted to a casing and thus makes up a battery pack. In this case, every battery module includes a cover and a housing. Therefore, there is a problem that a relatively large space may be required to form the battery pack with a certain number of battery modules, or a relatively small number of battery modules is mounted to form the battery pack having a certain volume.

To solve this problem, the battery pack 10 for the vehicle according to the disclosure is formed by a cell-to-pack method without battery modularization. Thus, the battery module 100 to be described later may include a plurality of battery cells stacked but not enclosed with the housing.

There may be a plurality of such battery modules 100, and the plurality of battery modules 100 may be seated on the lower casing 200. Specifically, the lower casing 200 may form a space in which the plurality of battery modules 100 is accommodated, and the plurality of battery modules 100 may be accommodated in this apace.

When the plurality of battery modules 100 is seated on the lower casing 200, the crossing members 300 may be inserted between the plurality of seated battery modules 100. For example, the crossing member 300 may be disposed to cross the lower casing 200 along a widthwise direction between the battery modules 100 adjacent to each other in a lengthwise direction. The crossing member 300 may be disposed between the battery modules 100 seated to be adjacent to each other in the lengthwise direction, and fastened to the lower casing 200.

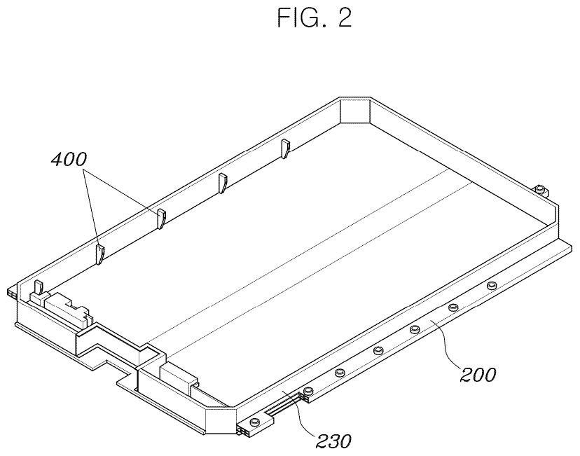

In some implementations, referring to FIG. 1, the lower casing 200 has a rectangular shape, but is not necessarily limited thereto. For example, FIG. 2 is a perspective view showing the shape of the lower casing 200. As shown in FIG. 2, the lower casing 200 may be formed to have an octagonal shape. Further, the lower casing 200 may be formed to have various shapes as well as the shapes shown in FIGS. 1 and 2.

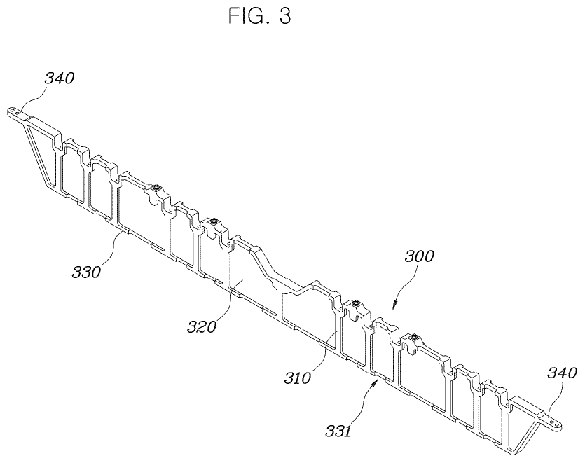

Next, the structure of the crossing member 300 will be described in detail with reference to FIG. 3.

FIG. 3 is a perspective view showing an example of a crossing member.

In some implementations, referring to FIG. 3, the crossing member 300 may be made of metal and molded by a casting process. Thus, the crossing member 300 may be thinly disposed between the battery modules seated to be adjacent to each other in the lengthwise direction, and may be disposed to cross the lower casing 200 along the widthwise direction, thereby ensuring the structural rigidity of the battery pack 10. However, this is merely an example, and is not necessarily limited thereto. For example, the crossing member 300 may be molded by a die-casting process.

In addition, the crossing member 300 may include a plurality of fastening portions 310 penetrating the crossing member 300 vertically, and a recessed portion 320 on both sides thereof between the fastening portions 310. The crossing member 300 is fastened to the lower casing 200, and thus may be required to have structural rigidity as well as coupling rigidity. Therefore, the crossing member 300 may be formed by a draft process to thinly form the recessed portion 320 having desired structural rigidity at positions other than the fastening portion 310, while having the coupling rigidity and the structural rigidity through the fastening portion 310 fastened to the lower casing 200.

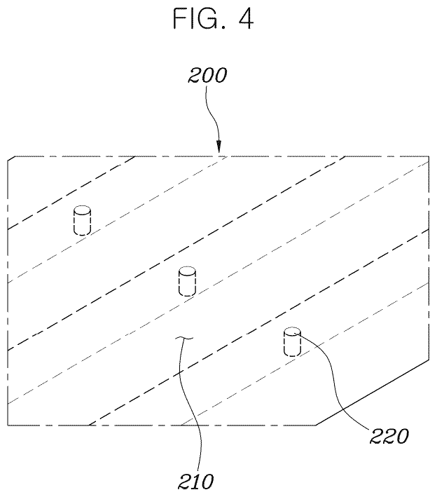

Referring back to FIG. 1, the crossing member 300 may be fastened to the lower casing 200. For example, the lower end of the crossing member 300 may be fastened to a seating surface where the plurality of battery modules 100 of the lower casing 200 is seated. To this end, the seating surface of the lower casing 200 may have a structure to which the crossing member 300 is fastened. This will be described with reference to FIG. 4.

FIG. 4 is an enlarged view of “A” in FIG. 1.

Referring to FIG. 4, a plurality of fastening taps 220 to which the crossing member 300 is fastened may be formed on the seating surface of the lower casing 200. The plurality of fastening taps 220 may be spaced apart from each other along the extending direction of the crossing member 300, and may be formed on the bottom of the seating surface of the lower casing 200.

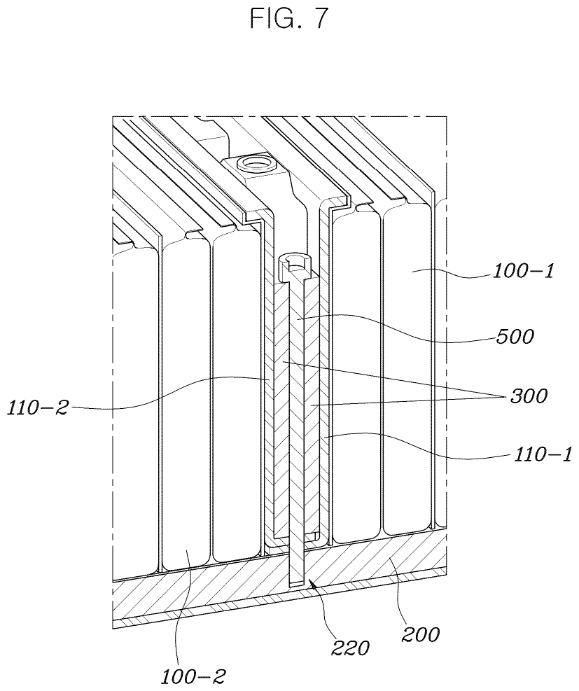

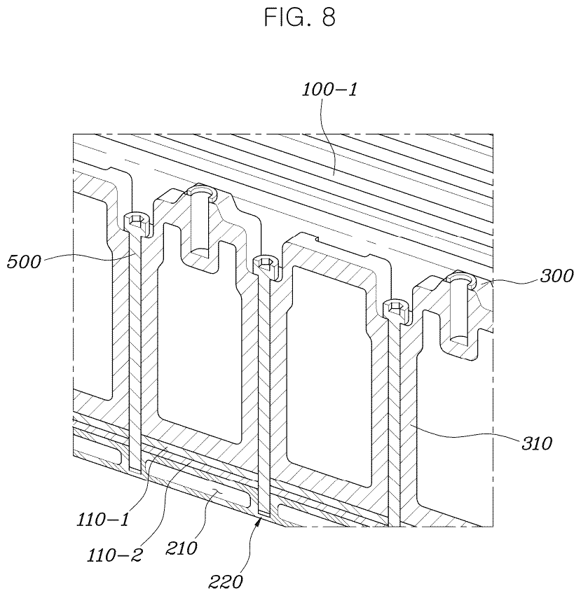

In addition, a plurality of cooling channels 210 may be formed along the lengthwise direction of the lower casing 200. The plurality of fastening taps 220 may be formed in areas other than positions where the cooling channels 210 are formed, and may be spaced apart along the extending direction of the crossing member 300. With this structure, the fastening shape between the crossing member 300 and the lower casing 200 will be described later with reference to FIGS. 7 to 8.

In some examples, referring back to FIG. 1, the battery module 100 may be seated on the lower casing 200 while including end plates 110 mounted to both sides thereof. In some implementations, the end plate 110 may be mounted corresponding to not one battery module 100 but two battery modules 100 adjacent along the widthwise direction of the lower casing 200. In other words, the end plate 110 may be formed corresponding to two battery modules 100 adjacent along the widthwise direction, while crossing the lower casing 200 along the widthwise direction of the lower casing 200. However, this structure is merely an example, and is not necessarily limited thereto.

When the plurality of battery modules 100 is seated on the lower casing 200 and the crossing member 300 is disposed between the seated battery modules 100 adjacent in the lengthwise direction, both sides of the crossing member 300 may be in close contact with the end plates of the seated battery modules adjacent, i.e., the battery modules facing each other in the lengthwise direction.

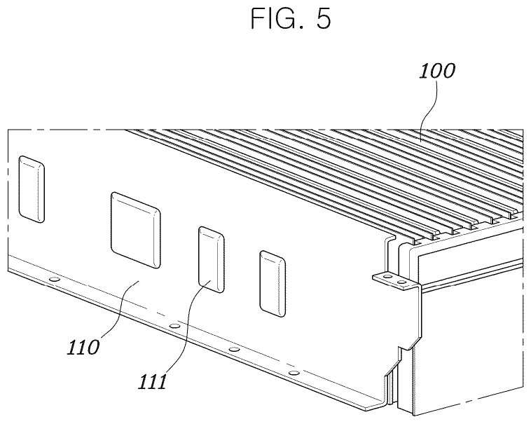

For example, when the crossing member 300 is formed by the draft process as described above to have the fastening portion 310 and the recessed portion 320, the end plate 110 may have a separate structure to be in close contact with both sides of the crossing member 300. This structure will be described with reference to FIG. 5.

FIG. 5 is an enlarged view of “B” in FIG. 1.

Referring to FIG. 5, the end plate 110 may include a plurality of guide portions 111. Specifically, a plurality of guide portions 111 may be formed to protrude from the side of the end plate 110 facing toward the crossing member 300. As the plurality of guide portions 111 is formed to protrude from the side of the end plate 110 facing toward the crossing member 300, the side of the crossing member 300 can be in close contact with the end plate 110 through the plurality of guide portions 111.

For example, the end plate 110 may be made of metal, and the plurality of guide portions 111 may be made of plastic. In this case, the plurality of guide portions 111 may be formed by insert injection molding on the side of the end plate 110.

When the plurality of guide portions 111 is formed protruding from the side of the end plate 110 facing toward the crossing member 300, the crossing member 300 may not be smoothly inserted in a space between the seated battery modules adjacent in the lengthwise direction. To this end, referring back to FIG. 3, the crossing member 300 may include a lower rib 330 formed on the bottom thereof where the recessed portion 320 is formed, and the lower rib 330 may be formed with a plurality of guide grooves 331 at positions corresponding to the plurality of guide portions 111 formed in the end plate 110. However, this is merely an example, and is not necessarily limited thereto. For example, according to the shape of the plurality of guide portions 111 formed in the end plate 110, separate guide grooves may be additionally formed in not only the lower rib 330 of the crossing member 300 but also an upper rib provided in the top of the recessed portion 320.

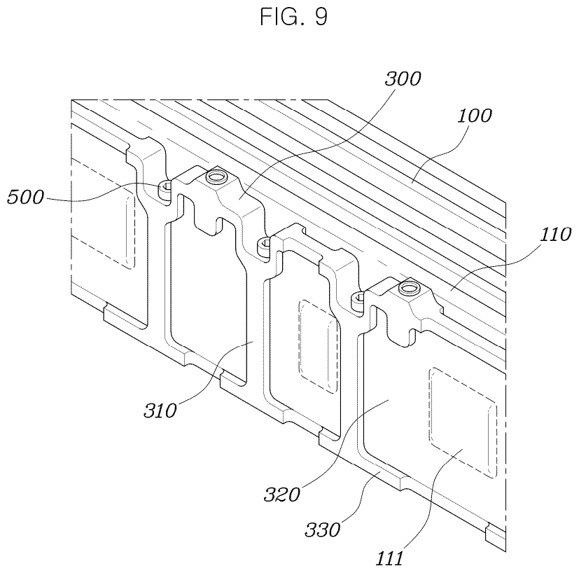

As the plurality of guide grooves 331 is formed in the crossing member 300, the crossing member 300 may be inserted between the seated battery modules adjacent in the lengthwise direction from above the lower casing 200 when the plurality of battery modules 100 is seated on the lower casing 200. In this case, the plurality of guide grooves 331 formed in the crossing member 300 may be inserted sliding along the plurality of guide portions 111 of the end plate 110. Such insertion will be described in detail with reference to FIG. 9.

Therefore, the crossing member 300 can be smoothly inserted between the seated battery modules adjacent in the lengthwise direction. Further, the plurality of guide portions 111 may serve as guides to prevent the crossing member 300 from moving out of an insertion position or being inserted incorrectly when the crossing member 300 is inserted. In other words, there is an effect on improving the assembly of the crossing member 300.

In some examples, the bottom of the crossing member 300 may be fastened to the lower casing 200, and the lateral side of the crossing member 300 may be additionally fastened to the lower casing 200 to ensure the rigid structure. In other words, the lower casing 200 may include a side member 230 formed at lateral sides along the widthwise direction of the lower casing 200, the plurality of battery modules 100 and the crossing member 300 are disposed between both side members of the lower casing 200, and the crossing member 300 may be fastened to the side member 230. Conventionally, both lateral ends of the crossing member 300 are in entire contact with and fastened to the side members 230 by inserting bolts penetrating the side member 230 and the crossing member 300 from the outside. However, the battery pack 10 is likely to be exposed to vibration and shock. When vibration and shock are generated, the vibration and the shock are transferred to the inside along the bolts inserted from the outside, and it is thus difficult to maintain the airtight performance of the battery pack 10.

To solve this, the side member 230 and the crossing member 300 according to the disclosure are fastened from the inside of the lower casing 200 rather than the outside. Therefore, the airtight performance of the battery pack 10 is maintained even though vibration and shock are applied to the battery pack 10.

Specifically, referring to FIG. 1, connection brackets 400 may be formed on inner surfaces of both side members 230 of the lower casing 200, the crossing member 300 may be disposed between both side members 230 of the lower casing 200, and both lateral ends of the crossing member 300 may be fastened to the connection brackets 400 of the side members 230. In other words, the crossing member 300 may be inserted and disposed in a space between the connection brackets 400 spaced apart from and facing each other.

For example, the connection bracket 400 may be formed on the inner side of the side member 230, and may be welded to the side member 230. However, this is merely an example, and is not necessarily limited thereto.

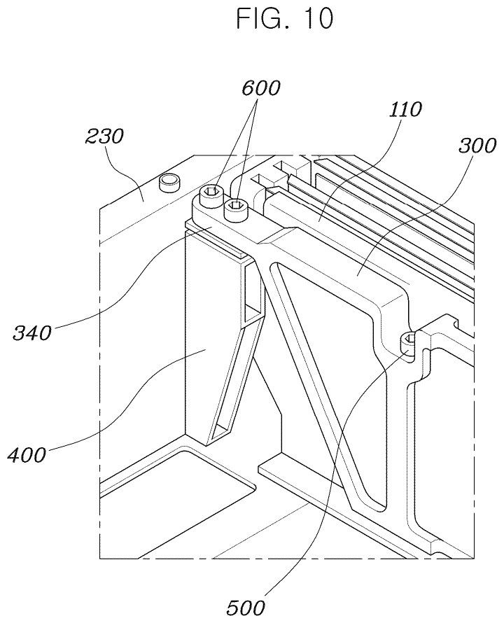

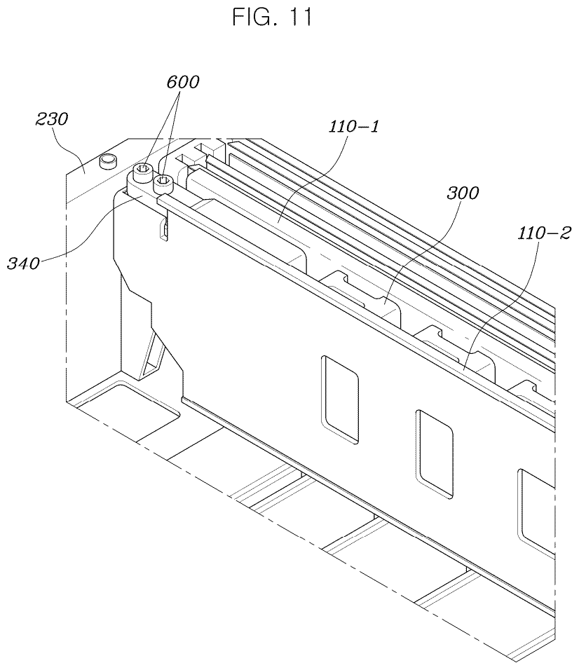

In some examples, referring to FIG. 3, protrusions 340 may be formed at both lateral ends of the crossing member 300 so as to be fastened to the connection brackets 400. Specifically, the protrusions 340 may be formed to protrude outwards from both lateral upper portions of the crossing member 300. As the crossing member 300 is inserted in the lower casing 200 from above the lower casing 200, the protrusions 340 of the crossing member 300 may be positioned on the top of the connection bracket 400, and the crossing member 300 and the connection bracket 400 are fastened by coupling the protrusions 340 and the connection bracket 400 in this state. The detailed fastening structure will be described later with reference to FIGS. 10 to 11.

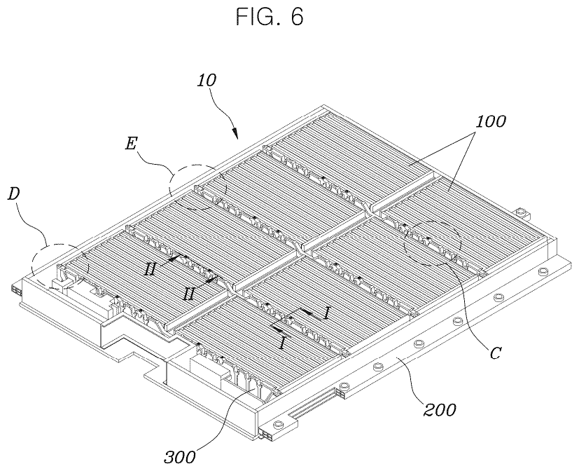

With the elements of the battery pack 10 for the vehicle according to the disclosure described above with reference to FIGS. 1 to 5, a fastening method or shape of the elements will be described below with reference to FIGS. 6 to 11.

FIG. 6 is a perspective view showing a battery back for a vehicle with a top cover removed.

FIG. 6 shows that the plurality of battery modules 100 and the crossing member 300 described above are seated on and mounted to the lower casing 200 to make up the battery pack 10 for the vehicle. For convenience, the description will be made excluding the upper cover of the battery pack 10 for the vehicle as shown in FIG. 6.

First, coupling between the bottom of the crossing member 300 and the lower casing 200 will be described with reference to FIGS. 7 to 8.

FIG. 7 is a view showing a cross-section taken along line I-I of FIG. 6, and FIG. 8 is a view showing a cross-section taken along line II-II of FIG. 6.

Referring to FIGS. 7 to 8, the crossing member 300 may be inserted between the battery modules 100-1 and 100-2 seated to be adjacent in the lengthwise direction, while being in close contact with the end plates 110-1 and 110-2 of the battery modules 100-1 and 100-2, lateral sides of which face each other, and being fastened to the lower casing 200 together with the pair of end plates 110-1 and 110-2 disposed on the lateral sides.

For example, at least one of the pair of end plates 110-1 and 110-2 may be bent at a lower end portion to overlap with a lower end portion of the crossing member 300, and the lower end portion of the crossing member 300, together with the bent lower end portions of the at least one end plate, may be fastened to the lower casing 200.

Further, the pair of end plates 110-1 and 110-2 may be bent at the lower end portions so that the lower end portions can be stacked up, and the lower end portion of the crossing member 300 may be fastened to the lower casing 200 along with the stacked lower end portions of the pair of end plates 110-1 and 110-2.

In addition, the crossing member 300 may be fastened to the lower casing 200 together with the pair of end plates 110-1 and 110-2 through a plurality of first fastening bolts 500 respectively inserted in the plurality of fastening portions 310. For example, the first fastening bolt 500 is inserted in the fastening portion 310 of the crossing member 300, and fastened to the lower casing 200 while penetrating the stacked lower end portions of the pair of end plates 110-1 and 110-2 at the bottom of the crossing member 300.

To fasten the first fastening bolt 500 to the lower casing 200, the lower casing 200 may be formed with a fastening tap 220 corresponding to the fastening portion 310 in an area other than positions where the plurality of cooling channels 210 is formed. Thus, the first fastening bolt 500 is fastened to the fastening tap 220 while penetrating the fastening portion 310 of the crossing member 300, so that the bottom of the crossing member 300 can be fastened to the lower casing 200.

In some examples, FIGS. 7 to 8 show that the crossing member 300 is in close contact with the end plate 110. This will be described with reference to FIG. 9.

FIG. 9 is an enlarged view of “C” in FIG. 6.

As described above, the end plate 110 is formed with the plurality of guide portions 111 protruding toward the lateral side of the crossing member 300, and the crossing member 300 is formed with the plurality of guide grooves 331 corresponding to the plurality of guide portions 111.

Referring to FIG. 9, the crossing member 300 includes the recessed portion 320 formed on the lateral side thereof, and the lower rib 330 is formed in the lower end of the recessed portion 320. In the lower rib 330, the plurality of guide grooves 331 may be formed at positions corresponding to the plurality of guide portions 111. Thus, when the crossing member 300 is inserted from above the lower casing 200, the plurality of guide grooves 331 of the crossing member 300 may slide along the plurality of guide portions 111.

Then, the plurality of guide portions 111 formed in the end plate 110 may be respectively positioned on the corresponding recessed portions 320 of the crossing member 300. Thus, the plurality of guide portions 111 may be positioned on and in close contact with the recessed portions 320, so that the crossing member 300 can be assembled being in close contact with the end plate 110.

Therefore, not only the assembly of the crossing member 300 but also the structural rigidity of the battery pack 10 are ensured after assembling the crossing member 300.

Next, it will be described with reference to FIGS. 10 to 11 that the crossing member 300 is fastened to the connection bracket 400 formed in the lower casing 200.

FIG. 10 is an enlarged view of “D” in FIG. 6, and FIG. 11 is an enlarged view of “E” in FIG. 6.

First, referring to FIG. 10, the crossing member 300 may be fastened to the connection brackets 400 through the protrusions 340 thereof. As the crossing member 300 is inserted from above the lower casing 200, the protrusions 340 of the crossing member 300 may be fastened while being positioned on the top of the connection brackets 400. In this case, the protrusions 340 and the connection brackets 400 may be bolted and fastened by at least one second fastening bolt 600 penetrating from above.

When the protrusions 340 are bolted and fastened to the connection brackets 400, it may be disadvantageous to ensure the rigidity because the protrusions 340 are merely portions protruding from the crossing member 300. Thus, reinforcing beads may be formed on the bottoms of the protrusions 340 to connect the bottoms of the protrusions 340 and the lateral end of the crossing member 300. In this way, the rigidity of the protrusions 340 is sufficiently ensured.

In some examples, both lateral ends of the crossing member 300 may be inclined to become narrower downwards, and thus a space may be formed to become wider downwards at a position between the lateral end of the crossing member 300 and the connection bracket 400. As both lateral ends of the crossing member 300 are formed to be inclined, a fastening force generated by bolting and fastening the protrusions 340 may be distributed, so that the crossing member 300 and the connection bracket 400 can be easily fastened and loosened.

In addition, both lateral surfaces of the connection bracket 400 may be in close contact with the end plates 110 of the battery modules seated to be adjacent to each other, and the protrusions 340 formed at both lateral ends of the crossing member 300 may be fastened to the connection brackets 400 along with the end plates 110 being in close contact with both lateral surfaces of the connection bracket 400.

Referring to FIGS. 10 to 11, the end plate 110 may be bent at an upper end portion being in close contact with the connection bracket 400, and the bent upper end portion may overlap with the upper end portion of the connection bracket 400. The protrusions 340 formed at both lateral ends of the crossing member 300 may be fastened to the connection bracket 400, together with the bent upper end portion of the end plate 110.

Further, the pair of end plates positioned on both lateral surface of the crossing member 300 may be bent so that the upper end portions thereof being in close with the connection bracket 400 can be stacked up together. The protrusions 340 formed at both lateral ends of the crossing member 300 may be fastened to the connection bracket 400 along with the stacked upper end portions of the pair of end plates.

As described above, the number of battery cells to be loaded into the battery pack is maximized in the battery pack for the vehicle according to the disclosure, thereby maximizing the range of the vehicle.

In addition, the structural rigidity is sufficiently ensured through the crossing member inserted between the battery modules even though ancillary components are reduced, thereby improving structural.

Further, the crossing member is fastened to the battery modules inside the casing of the battery pack, thereby ensuring the airtight performance of the casing even in the event of vibration and shock.

Although specific implementations of the disclosure have been illustrated and described as above, various modifications and changes can be made by a person having ordinary knowledge in the art without departing from the scope of technical ideas defined by the appended claims.

Therefore, the foregoing detailed description should not be construed as limiting in all aspects but considered exemplary. The scope of the disclosure should be determined by reasonable interpretation of the appended claims, and all changes within equivalent scope of the disclosure fall within the scope of the disclosure.

What is claimed is:

1. A battery pack for a vehicle, comprising:
a plurality of battery modules;
a lower casing that supports the plurality of battery modules;
a crossing member that extends across the lower casing along a widthwise direction of the lower casing, the crossing member being disposed between adjacent battery modules among the plurality of battery modules that are disposed adjacent to each other in a lengthwise direction crossing the widthwise direction; and
a pair of end plates that are disposed at lateral sides of the adjacent battery modules and face each other,
wherein the cross member is in contact with the pair of end plates and fastened to the lower casing together with the pair of end plates.

2. The battery pack of claim 1, wherein a lower end portion of at least one end plate of the pair of end plates is curved and overlaps with a lower end portion of the crossing member, and
wherein the lower end portion of the crossing member is fastened to the lower casing along with the lower end portion of the at least one end plate.

3. The battery pack of claim 1, wherein lower end portions of the pair of end plates are curved so that the lower end portions overlap with each other, and
wherein the lower end portion of the crossing member is fastened to the lower casing along with the lower end portions of the pair of end plates.

4. The battery pack of claim 1, further comprising a plurality of first fastening bolts that couple the crossing member to the lower casing together with the pair of end plates,
wherein the crossing member comprises a plurality of fastening portions that extends through the crossing member in a vertical direction, each of the plurality of fastening portions receiving one of the plurality of first fastening bolts.

5. The battery pack of claim 4, wherein the crossing member is made of metal and molded by a casting process.

6. The battery pack of claim 5, wherein the crossing member comprises a plurality of recessed portions that are recessed in the lengthwise direction from lateral surfaces of the crossing member facing the lateral sides of the adjacent battery modules, and
wherein each of the plurality of recessed portions is disposed between two of the plurality of fastening portions.

7. The battery pack of claim 4, wherein the lower casing comprises:
a plurality of cooling channels; and
a plurality of fastening taps that are disposed so as not to overlap the plurality of cooling channels and spaced apart from one another in the widthwise direction of the crossing member,
wherein the plurality of first fastening bolts are fastened to the plurality of fastening taps, respectively.

8. The battery pack of claim 1, wherein each of the pair of end plates comprises a plurality of guide portions that protrude from a lateral side thereof and are in contact with a lateral surface of the crossing member.

9. The battery pack of claim 8, wherein the pair of end plates are made of metal, and
wherein the plurality of guide portions are made of plastic and disposed at the lateral side of the pair of end plates by an insert-injection molding process.

10. The battery pack of claim 8, wherein the crossing member comprises:
a plurality of recessed portions formed at the lateral surface of the crossing member;
a plurality of lower ribs disposed below the plurality of recessed portions; and
a plurality of guide grooves formed at the plurality of lower ribs at positions corresponding to the plurality of guide portions,
wherein the plurality of guide portions are configured to pass through the plurality of guide grooves, respectively, based on the crossing member moving relative to the pair of end plates from a position above the pair of end plates, and
wherein the crossing member is configured to be inserted between the pair of end plates based on moving relative to the pair of end plates from the position above the pair of end plates to a position in which the plurality of guide portions are positioned above the plurality of recessed portions of the crossing member.

11. The battery pack of claim 1, wherein the lower casing comprises a plurality of side members that form side surfaces of the lower casing,
wherein the plurality of battery modules and the crossing member are disposed between the plurality of side members of the lower casing,
wherein each of the side members comprises a connection bracket disposed at an inner side thereof, and
wherein the crossing member comprises end portions that are fastened to the connection brackets of the side members, respectively.

12. The battery pack of claim 11, wherein the crossing member comprises protrusions that protrude laterally outwards from upper portions of the end portions of the crossing member, respectively, and
wherein the crossing member is inserted to the lower casing from a position above the lower casing based on the protrusions being fastened to top portions of the connection brackets, respectively.

13. The battery pack of claim 12, wherein the connection brackets are spaced apart from each other and face each other in the widthwise direction of the lower casing, and
wherein the crossing member is disposed between the connection brackets.

14. The battery pack of claim 12, further comprising at least one second fastening bolt that is inserted from above one of the protrusions and fastens the one of the protrusions to one of the connection brackets.

15. The battery pack of claim 11, wherein the crossing member has lateral end surfaces that are inclined inward with respect to the side members, respectively, such that a width of the crossing member decreases toward the lower casing, and
wherein a space between one of the lateral end surfaces of the crossing member and one of the connection brackets increases toward the lower casing.

16. The battery pack of claim 11, wherein both lateral surfaces of each of the connection brackets are in contact with the pair of end plates, and
wherein the end portions of the crossing member are fastened to the connection brackets together with the pair of end plates that are in contact with the lateral surfaces of each of the connection brackets.

17. The battery pack of claim 16, wherein upper end portions of the pair of end plates are curved and in contact with an upper end portion of each of the connection brackets, and
wherein the end portions of the crossing member are fastened to the connection brackets, respectively, along with the upper end portions of the pair of end plates.

18. The battery pack of claim 17, wherein the upper end portions of the pair of end plates are stacked, and
wherein each of the end portions of the crossing member is fastened to one of the connection brackets along with the upper end portions of the pair of end plates.
